(19) United States
(12) Patent Application Publication
(10) Pub. No.: US 2002/0123330 A1
(43) Pub. Date: Sep. 5, 2002

(54) Wireless internet access with enhanced bandwidth capabilities

(76) Inventor: Robert C. Yen, Milpitas, CA (US)

Correspondence Address: BEYER WEAVER & THOMAS LLP, P.O. BOX 778, BERKELEY, CA, 94704-0778, US

(21) Appl. No.: 10/068,793

(22) Filed: Feb. 6, 2002

Related U.S. Application Data
(60) Provisional application No. 60/266,924, filed on Feb. 6, 2001.

(51) Int. Cl. H04J 1/00; H04Q 7/20

(52) U.S. Cl. 455/414; 455/422; 455/434

(57) ABSTRACT

Disclosed are techniques to improve use of wireless devices. One aspect pertains to a method for identifying the geographical cellular area and the wireless carrier network of a mobile wireless device user using a bank of wireless cell phones and/or transceivers in each geographical cellular area. Another aspect pertains to a method for reduction of bandwidth requirements based on user-specified bandwidth trade-off options. Still another aspect pertains to a keyboard module contains a subset key set of a complete computer keyboard.

### CROSS-REFERENCE TO RELATED APPLICATIONS

This application claims the benefit of U.S. Provisional Patent Application No. 60/266,924, filed Feb. 6, 2001, and entitled “METHODS, SYSTEM AND APPARATUS FOR MOBILE INTERNET NETWORK,” and which is hereby incorporated by reference herein.

This application is also related to: (i) U.S. patent application Ser. No. 09/578,816, filed May 24, 2000, and entitled “METHOD AND SYSTEM FOR REDUCTION OF DELAY AND BANDWIDTH REQUIREMENTS IN INTERNET DATA TRANSFER,” and which is hereby incorporated by reference herein; and (ii) U.S. patent application Ser. No. 09/967,532, filed Sep. 27, 2001, and entitled “WIRELESS INTERNET ACCESS WITH ENHANCED BANDWIDTH CAPABILITIES,” and which is hereby incorporated by reference herein.

### BACKGROUND OF THE INVENTION

1. Field of the Invention

This patent application is related to utilizing the wireless devices, and more particularly to a utilization of the Internet via mobile wireless devices.

2. Description of the Related Art

The Mobile Wireless Internet Service Providers have the need to identify the Mobile Wireless Device Users' Base Station Geographical Area or Wireless Cell Area for Purposes of Effectively Utilizing Mobile Wireless Channel Bandwidth and Dynamically Allocating Cell Based Wireless Channels to Users in Applications involving but not limited to Unicast, Multicast, and Broadcast Employing One or More Wireless Cell Phone Channels. Further, the Mobile Wireless Internet Service Providers need such real time Mobile Wireless Device Users' Geographical Area information for targeting area location sensitive commercial advertisements and other promotions. Mobile Wireless Internet Service Providers need such real time Users' Geographical Area information for many other functions but not limited to the followings: pricing structures, commercial advertisement and promotions, services and constraints in the area available to users, managing the switching and directing traffics of the calls to the cells, providing for backup, interfacing with telephone or other network networks, monitoring traffic, protocols, performing charging, testing and diagnostic and other functions, and managing the overall wireless ISP network, . . . etc. In additional, it also provides the crucial users' geographical area information for the wireless ISP to manage and to direct the internet data transmission be sent to the Bank of Wireless Cellular Phones and/or Transceivers sites of the Mobile Wireless Device Users' Geographical Area via Other Low Cost High Bandwidth Transmission Medium (Fiber Optic Lines, T1 Lines, ADSL, Cable, . . . etc.) so only the local Mobile Wireless Cell Phone Charges are incurred, and the high roaming charges imposed by the Mobile Wireless Network Carriers such as MCI, AT & T Wireless, Verizon Wireless, can be avoided. Usual attempts to identify Mobile Wireless Device User's Geographical Area are to employ the use of GPS, Global Positioning System, or the Mobile Wireless Base Station Area information, data, and control signals provided by Wireless Network Carriers such as MCI, US Sprint, AT & T Wireless Services, and Verizon Wireless.

However, the use of Global Positioning System (GPS) creates additional costs to the Mobile Wireless Internet Service Providers and their Subscribers (Mobile Wireless Device Users). It not only require additional hardware be implemented in each user's mobile wireless device, but it also requires the ISP or the users to incur cost expenses to maintain the GPS services. As the number of GPS provider is quite limited in the market place, the pricing and costs for obtaining such GPS service and its quality and availability can not be assured. The Mobile Wireless Internet Service Providers will not be able to have total control of the crucial data vital to the survival of its own business.

Another problem of using GPS is the privacy concern. Global Position System tracks Mobile Wireless Device User's location with varying degree of accuracy from 10 feet to 100 feet of the exact location. Even though the Mobile Wireless Device Users might have the option to turn off the GPS, nevertheless, the users are under a dark cloud constantly wondering whether the GPS is truly turned off or accidentally left on. Mobile Wireless Device Users' private life or some private confidential visits to various locations might be electronically monitored and recorded without users' knowledge.

The other usual attempts to identify Mobile Wireless Device User's Geographical Area is to acquire such real time Mobile Wireless Users' Base Station Area information, data, and control signals from the Wireless Network Carriers such as MCI, US Sprint, AT & T Wireless Services, and Verizon Wireless, which actually owned and operated the Mobile Wireless Network for the Wireless Internet Service Providers.

The Wireless Internet Service Providers often depend upon Wireless Networks owned and operated by Others such as AT&T Wireless Services and Verizon Wireless to deliver the Wireless Internet Services. The Wireless Internet Service Providers depend on wireless carriers to transmit the wireless service to the wireless internet subscribers and must purchase airtime from the wireless carriers for that purpose. The Wireless Internet Service Providers' are depending on the wireless carriers to provide critical real time Mobile Wireless Device Users' Cellular Geographical Area data and information to manage Wireless ISP's own Network and Bandwidth needs economically.

The ability of the Wireless Internet Service Providers to grow and to maintain sufficient service quality also depends on its ability to obtain critical real time Mobile Wireless Device Users' Base Station Geographical Area data, and control signals, and sufficient wireless capacity on the networks of the Wireless Carriers at reasonable costs. Some of the wireless carriers might not want to let the Independent Wireless Internet Service Providers to have direct access to such critical real time Mobile Wireless Users' Base Station Geographical Area data, control signals, and other information because it will undermine the very purpose of the wireless carriers to sell wireless bandwidth at a premium price.

Other problems are that some of the wireless carriers are, or could become, the Wireless Internet Service Providers themselves, and might become competitors, and may refuse to provide the Independent Wireless Internet Service Providers access to their wireless networks and mobile wireless device users' base station geographical area information at reasonable price.

Accordingly, what is needed is a system that allows more flexible and convenient control over its ability to obtain critical real time Mobile Wireless Device Users' Base Station Geographical Area data, control signals, and other relevant information to be used for the allocation of additional wireless bandwidth, and over the transfer of data between wireless client and host server systems on the Internet, which includes sharing of data transfers by a number of clients requesting a link to the same web site by multicast or broadcast data transfer, and other methods of accessing image, catalogue and advertisement data stored in the mass storage mediums at the clients' server systems, physical distribution by mail or any other retail methods of the mass storage medium (such as CD ROM, . . . etc.) and/or electronic distribution using broadcast, multicast, and unicast transmission of such data files containing the coded image, catalogue or other data for a particular web site or for a number of web sites.

Utilization of the Wireless Networks such as Mobile Phone Networks or Cordless Phone Network to access the World Wide Web, i.e., a global hypermedia document that resides on and stretches across most of the Internet, commonly involves users entering a site address, i.e., a URL (uniform resource locator), or by selecting a link on a displayed web page of Host Web Site.

During the process of requesting a site and transferring data, the client system waits. Unfortunately, when the site being accessed contains large image files, the wait for a full data transfer can become excessive. In certain situations, such as international web sites or sites or ISPs (Internet Service Providers) serving Mobile Wireless Internet Access with limited telecommunication channel capacity, data transfer is slow. The time wasted waiting is not only inconvenient to the user, but may be costly for those situations in which users pay for use of the Internet based on the length of Mobile Wireless connection time. In the event a large number of Mobile Wireless users in the same Geographical Mobile Wireless Cell Area requesting data transfers of large image or data files from different remote host web sites or through the mobile wireless ISPs with limited Mobile Wireless telecommunication channel capacity (bandwidth) in that geographical Mobile Wireless Cell Area, the problem will occur for very slow data transfer to the individual internet user, and data lost or data requests terminated due to long transmission time. The remote host computer servers serving the remote host web sites may crash due to the overload in users' requests because of the repeated multiple requests for the same web page from the termination of earlier data transmission.

Other problems with the Wireless Internet is the limited wireless channel bandwidth available for massive amount of data transmission. Therefore, wireless connection time is expensive. Usual attempts to make the use of Wireless Internet less expensive and more convenient to use is to create dedicated web pages stripped of massive graphical images with optimized contents for Mobile Wireless applications only.

However, the elimination of images from the Web Pages defeats the purpose of the having a graphical browser for the web pages and limits the depth of the information provided and limits the effect of the advertisements and visual information provided. Other problems for accessing the Web Sites with regular contents not optimized for Wireless Internet Uses are the long data transmission time required for transmitting large volume of graphical and non core data over the limited wireless bandwidth offered to the Wireless Internet Subscriber. The long data transmission time will often cause the data transmission to be terminated because of the certain time limit imposed by the host sites and/or ISP servers. It might also cause multiple requests for the same Web Pages because previous requests have been terminated or non responsive due to the long transmission time. The multiple requests for the same Web Page data will also contribute to the problem of congesting the net and the host site computers.

Other attempts to increase the Wireless Channel Capacity involve the development of private Cordless Wireless Network in a densely populated user area such as University Campus, Corporate Sites, and Hotels or Convention Centers. However, such private Wireless Network is expensive to install, and the users only have the enhanced Wireless Internet Performance within such an area. Outside of such area, the users still face the same problem as cited above, or the users have to pay the additional fees for using the Private Wireless Network in different areas.

Accordingly, what is needed is a system and method that allows more flexible and convenient control over the amount of data to be transferred to and received by the mobile wireless internet users at the users' option, and without any attempts or effects to alter or to modify the contents of the data to be transmitted. Such Methods and Systems to reduce the Bandwidth Requirements in Mobile Wireless Internet Applications includes assigning and/or leasing to each and every mobile wireless internet subscriber or user a block of buffer memory storage capacity for purposes of mitigating the difference in data transmission speed between low speed mobile wireless internet access to the mobile wireless ISP and the much higher speed data transmission of the web page requested from the remote host web sites to the mobile wireless ISP; and other methods for allowing users to have the options of setting different color tones and/or monochrome tones, different resolution levels, and different data compression options for the web pages requested by electronic means similar to the features available in a commercial facsimile machine employing optical scanning of a printed document for fax transmission.

Conventional keyboard design for portable handheld computer and/or electronic devices traditionally uses fewer number of keys and smaller sized keys than that of a full sized keyboard. The feature of such small sized keys is inconvenient to the users especially for those users having big fingers. It often resulted in typing the wrong keys and slow typing speed, which causes low productivity when users are using the portable devices to do work.

Furthermore, users of a keyboard are already used to a certain habit of typing, which is directly related to the designs of the keyboard the users are used to. The often rearranged positions for certain keys and the omission of certain function keys in the conventional portable handheld devices create problems that force users to change their typing habit. As a consequence of the forced change in typing habit during the use of the portable pocket devices, users' productivity suffers.

Therefore, there is a strong need to the design of a portable handheld keyboard module which preserves all the positions, keys, and sizes of the near full size keyboard, and at the same time, the keyboard modules are light weighted, small sized, and easy to be carried by a users.

This invention solves the above mentioned problems by methods of using separate portable handheld keyboard modules connected together with one or a pair stretchable cable to form a complete keyboard.

### SUMMARY OF THE INVENTION

In one aspect, the invention meets these needs and provides method and system aspects for Identifying Mobile Wireless Device Users' Base Station Geographical Area or Wireless Cell Area, allowing flexible and convenient control over the allocation of additional wireless bandwidth, and over the transfer of data between wireless client and host server systems on the Internet.

In a method aspect, the method includes identifying the geographical cellular area and the wireless carrier network of the mobile wireless device user. Use of the users' main subscribed mobile wireless channel to respond and to engage in a two way communication handshake protocols with the Web Host Sites and/or the Wireless Internet Service Provider to identify users' cellular base station geographical area.

The method further includes establishing geographical cellular cells area for each and every wireless carrier network available in that geographical area; establish banks of wireless receivers or wireless phones/devices which are dynamically assigned the corresponding wireless cellular phone numbers and/or certain wireless channel capacities in each wireless geographical area.

In a further aspect, a method for allowing control to dynamically update the mobile wireless internet users about the mobile wireless phone numbers and/or the frequency channels, and/or the protocols for the channels used in the geographical area of the wireless internet user's location.

In a further aspect, a method for allowing control of the mobile wireless device to scan over a range of mobile wireless phone numbers and/or the frequency channels to identify the wireless phone numbers and/or the frequency channels carrying the control signals and handshake protocol messages.

In a further aspect, a method for using wireless internet user's own subscribed, assigned wireless phone number (user's assigned channel) for sending acknowledgement and other handshake protocols to the wireless internet service provider's network management servers in response to the control signals and handshake protocol messages broadcasted by one or more wireless phone numbers and/or frequency channels in the mobile wireless geographical area the users are located and its immediate adjacent area.

In a further aspect, a method for measuring the received signal strength, signal to noise ratio, and bit error rate, and/or any other measurement for determining and distinguishing the mobile wireless phone numbers and/or frequency channels scanned and received by the mobile wireless device from several adjacent geographical area.

In a further aspect, a method for mapping and compare the wireless phone numbers and/or the frequency channels identified by users' mobile wireless device to a table of assigned wireless phone numbers and/or frequency channels in each and every mobile wireless geographical area.

With the present invention, more flexible control to identify users' mobile wireless device geographical area is achieved. The availability of such users' mobile wireless device geographical area data and information allows the wireless internet service provider to transmit area sensitive information and advertisements and to assign additional wireless channels for unicast, multicast, and broadcast use by installing a bank of wireless receivers subscribed from a wireless network carrier in each geographic area. It will reduce the wireless ISP's dependency on the wireless network carriers to adjust its channel capacity needs as demands changes. Therefore, making the wireless internet ISP a true independent enterprise not controlled and/or monopolized by the wireless network carriers. With the present invention, the wireless internet multicast and broadcast can be achieved without the control and interference by the wireless network carrier. The reduction of bandwidth required for servicing large number of wireless internet users requesting same web pages over an allowed programmable waiting time using multicast method provides cost savings to the wireless air time and improves the data transmission speed and reduce the delays commonly associated with data transfers on the wireless internet.

Another aspect of the present invention meets these needs and provides method and system aspects for Mobile Wireless Internet Users Setting Different Color Tones, Resolutions and Data Compression Options, allowing flexible and convenient control over the requirements of mobile wireless bandwidth, and over the amount of data transferred from the mobile wireless internet service provider's server to the mobile wireless internet users' computing device.

In a method aspect, the method includes allocations to each and every mobile wireless internet subscriber or user a block of buffer memory storage capacity; a web page from the mobile wireless internet service provider to provide the subscriber user a table of the options of setting different color tones and/or monochrome tones, different resolution levels, and different data compression options for the web pages requested by electronic means similar to the features available in a commercial facsimile machine employing optical scanning of a printed document for fax transmission.

As yet another aspect, methods and systems to reduce the Physical Size of a Computer Keyboard for Portability and Ergonomics by connecting two or more modules of the computer keyboards through flexible and bendable physical support material or frames. Such physical support material can be two flexible and bendable metal cable housed inside the keyboard module. Such physical support cables can be pulled out at a stretchable length from the keyboard module. Electrical connections between the keyboard modules are through electrical wires inserted and housed inside such cables. The end point of the cable is designed as an electrical plug (similar to the popular audio and video plug) with electrical connections separated by several insulation rings. Each keyboard module has pairs of plug holes at the opposite side of the physical support cable. Such plug holes are designed for the physical support cable to be inserted as a mechanical support of the connected keyboard modules. Such plug holes are also designed for electrical connections to make electrical contacts to the different electrical contact rings at the tip of the physical support cable. A Design to allow each keyboard module to contain only a subset of the complete computer keyboard keys so each module can designed with smaller physical size and dimension for easy portability. Two or three different and complimentary keyboard modules are connected to form a complete computer keyboard with same ordering and configurations.

### DETAILED DESCRIPTION OF THE INVENTION

A. Geographical Area Detection Using Mobile Phone Banks

Methods and Systems To Identify Mobile Wireless Device Users' Base Station Geographical Area or Wireless Cell Area through the Installation of a Wireless Cellular Phone or a Transceiver with a Different Cellular Phone ID or Channel ID in Each and Every Designated Wireless Base Station Geographical Area of Wireless Cell Area to Cause Specially Coded Control Signals and Handshake Protocols Messages from the Wireless Internet Service Provider to be Transmitted and Received by All Mobile Wireless ISP Subscribers' Mobile Wireless Devices.

To identify users' mobile wireless device base station geographical area or Wireless Cell Area through the Installation of a Wireless Cellular Phone or a Transceiver with a Different Cellular Phone ID or Channel ID in Each and Every Designated Wireless Base Station Geographical Area of Wireless Cell Area to Cause Specially Coded Control Signals and Handshake Protocols Messages from the Wireless Internet Service Provider to be Transmitted and Received by All Mobile Wireless ISP Subscribers' Mobile Wireless Devices.

One or More Cell Phone Numbers are Dynamically Programmed and Designated to the Bank of Cell Phones or Wireless Transceivers in Each and Every Wireless Geographical Base Station Area Messages, protocols and other control signals were sent by the wireless internet service providers through the wireless frequency channels associated with the Wireless Cell Phone Numbers Designated in each and every Geographical Base Station Area.

Users' Wireless Device or Cell Phone are designed and programmed to scan the Predetermined Set of Wireless Cell Phone Numbers and/or the entire Wireless Cell Phone Carrier Frequencies to Track and to Lock onto the particular Cell Phone Number Designated to the Wireless Geographical Base Station Area of User's Wireless Device; and to Engage in the Proper Handshake Protocols to Identify the User's ID and to identify the Wireless Cell Phone Frequency or the Wireless Cell Phone Number it Tracked to Determine User's Geographical Wireless Base Station Area.

Mobile Telephone Switch Office (MTSO) is the control element for the system. It is responsible for switching the calls to the cells, providing for backup, interfacing with telephone or other network networks, monitoring traffic, protocols, performing charging, testing and diagnostic and other functions, and managing the overall network.

The mobile User's Wireless Device is the mobile transceiver. It contains a frequency-agile machine that allows it to change to a particular frequency designated for its use by the MTSO. The cell site contains the Base Station, which is the air interface between the mobile Users' Wireless Device and the MTSO. By receiving signals and directions from the MTSO, the base station sends and receives traffic to and from the mobile Users' Wireless' Device.

B. Reduction in Wireless Bandwidth Requirements

Methods and Systems to reduce the Bandwidth Requirements in Mobile Wireless Internet Applications by assigning and/or leasing to each and every mobile wireless internet subscriber or user a block of buffer memory storage capacity for purposes of mitigating the difference in data transmission speed between low speed mobile wireless internet access to the mobile wireless ISP and the much higher speed data transmission of the web page requested from the remote host web sites to the mobile wireless ISP; and for purposes of users' defined options of setting different color tones and/or monochrome tones, different resolution levels, and different data compression options for the web pages requested by electronic means similar to optical scanning of the web pages printed for fax transmission and data compression at different color or monochrome tones and different resolution levels.

(1) Mobile Wireless Internet Subscriber/User is connected to the Mobile Wireless Internet Service Providers via a paid local Radio Frequency low bandwidth Cell Phone Channel through a wireless modem and a mobile wireless cell phone or a transceiver;

(2) Mobile Wireless Internet User requests a Web page from a Remote Host Web Sites;

(3) The Web page requested contains large amount of high resolution color images and graphical data for advertisement and other purposes;

(4) The Remote Host Web Sites is a popular site with data centers and low cost high speed communication links such as T1 trunk, Fiber Links, . . . etc. connected to the Internet;

(5) The Mobile Wireless Internet Service Provider is connected to the Internet through low cost high speed communication links such as fixed wire T1 trunk, Fiber Links, . . . etc.;

(6) User's requests for the Web page were received by the Remote Host Web Sites through the Mobile Wireless ISP;

(7) The Remote Host Web Sites respond to Users' requests by sending protocol information which includes but not limited to the size and amount of data to be transmitted for the web page requested;

(8) The Mobile Wireless Internet Service Provider's Servers processed the protocols, and compare the size and amount of data to be transmitted to a set of criteria specific to each and every mobile wireless internet user.

(9) Such Criteria designed for each users includes but not limited to the followings: Size and amount of data to be transmitted directly to the users without been temporarily stored and parked at user's designated buffer memory storage space; the priority of wireless transmission; the availability of the wireless bandwidth at the time of such requests; the availability of multicast and/or broadcast feature for this web page; the amount of delay allowed for such transmission; pricing of such transmission; . . . etc. and other criteria;

(10) If the size and amount of data of the web page requested by the mobile wireless internet user is large than the amount determined by the criteria, and the mobile wireless transmission of such data is to be slow and expensive; the Mobile Wireless ISP responds to the user with a web page listing options available to reduce the amount of data to be transmitted through mobile wireless channels to continue the down load of the web pages users requested;

(11) Mobile Wireless Internet subscriber/user selects options of monochrome or gray tone (as opposed to 256 Color tones) setting lower resolution levels (such as 75 pixel per inch as opposed to 300 pixel per inch), and different data compression options (such as text block to be encoded using ASCII codes as oppose to bit map image, . . . etc.) for the web pages requested by electronic means similar to the features available in a commercial facsimile machine employing optical scanning of a printed document for fax transmission;

(12) The Servers at the Mobile Wireless Internet Service Provider perform data manipulations and computations to convert the web pages stored in user's buffer memory storage space in accordance with the settings and options the mobile wireless internet subscriber/user selected;

(13) The data manipulations and computations at the ISP sites are to be performed using special hardware, software, and special algorithm to off load computation burden away from ISP Servers;

(14) The Web Pages requested by users are scanned electronically to a lower resolution gray scale or color pages (for example, converted from 300 dpi/256 level color image into 75 dpi, 8 level gray scale image with text block encoded using ASCII), and now contain a much smaller amount of data to be transmitted;

(15) The reduced resolution version of the Web Pages requested are transmitted through Mobile Wireless Channels by the Mobile Wireless ISP to the subscriber/user;

C. Small-Scale Keyboard

Methods and Systems to reduce the Physical Size of a Computer Keyboard for Portability and Ergonomics by connecting two or more modules of the computer keyboards through flexible and bendable physical support material or frames. Such physical support material can be two flexible and bendable metal cable housed inside the keyboard module. Such physical support cables can be pulled out at a stretchable length from the keyboard module. Electrical connections between the keyboard modules are through electrical wires inserted and housed inside such cables. The end point of the cable is designed as an electrical plug (similar to the popular audio and video plug) with electrical connections separated by several insulation rings. Each keyboard module has pairs of plug holes at the opposite side of the physical support cable. Such plug holes are designed for the physical support cable to be inserted as a mechanical support of the connected keyboard modules. Such plug holes are also designed for electrical connections to make electrical contacts to the different electrical contact rings at the tip of the physical support cable. A Design to allow each keyboard module to contain only a subset of the complete computer keyboard keys so each module can designed with smaller physical size and dimension for easy portability. Two or three different and complimentary keyboard modules are connected to form a complete computer keyboard with same ordering and configurations.

What is claimed is:

1. A method for identifying the geographical cellular area and the wireless carrier network of a mobile wireless device user using a bank of wireless cell phones and/or transceivers in each geographical cellular area.

2. A method for identifying the geographical cellular area and the wireless carrier network of a mobile wireless device user using a bank of wireless cell phones and/or transceivers in each and every geographical cellular area, the method comprising:
establishing one or multiple wireless phone numbers and devices to receive broadcasting messages, protocols, and other control signals from a wireless internet service provider in each and every mobile wireless base station geographical area;
establishing the wireless internet users' geographical area through receiving area designated messages, protocols, and other control signals by scanning the frequency channels;
tuning in users' mobile wireless devices to the one or multiple wireless phone numbers and devices; and
receiving the broadcasting messages, protocols, and other control signals from the wireless internet service provider in each and every mobile wireless base station geographical area.

3. A method for using wireless internet user's own subscribed, assigned wireless phone number (user's assigned channel) for sending acknowledgement and other handshake protocols to a wireless internet service provider's network management servers in response to the control signals and handshake protocol messages broadcasted by one or more wireless phone numbers and/or frequency channels in the mobile wireless geographical area the users are located and its immediate adjacent areas.

4. A method for measuring the received signal strength, signal to noise ratio, and bit error rate, and/or any other measurement for determining and distinguishing the mobile wireless phone numbers and/or frequency channels scanned and received by the mobile wireless device from several adjacent geographical areas.

5. A method for managing buffer capacity at the site of a wireless internet service provider, said method comprising:
mapping and comparing wireless phone numbers and/or frequency channels identified by users' mobile wireless devices to a table of assigned wireless phone numbers and/or frequency channels in each and every mobile wireless geographical area; and
establishing a buffer memory storage capacity for each mobile wireless internet user or subscriber to temporarily store internet data that a mobile wireless internet user has requested and been delivered by a remote Host Web Sites through low cost high speed transmission link to the servers at the site of the wireless internet service provider.

6. A method for reduction of bandwidth requirements based on user's defined level of resolutions and compression scheme, the method comprising:
establish one or multiple buffer memory storage space for each mobile wireless internet service subscriber/user at servers of a mobile wireless internet service provider; and
establish a web page or other means from the mobile wireless internet service provider to provide the subscriber/user bandwidth trade-off options to be applied to requested web content.

7. A method as recited in claim 6, wherein the bandwidth trade-off options are presented to the subscriber/user as a table or list.

8. A method as recited in claim 6, wherein the bandwidth trade-off options pertain to one or more of different color tones and/or monochrome tones, different resolution levels, and different data compression options.

9. A method as recited in claim 6, wherein said method further comprises:
temporary storage of the complete or partial web page data requested by the mobile wireless internet subscriber/user and transmitted by the remote web host sites.

10. A method as recited in claim 9, wherein the temporary storage of the complete or partial web page data are stored at the servers of the mobile wireless internet service provider.

11. A method and means to reduce the amount of data for web pages requested by a mobile wireless internet service subscriber/user by reducing resolution and/or color level of the web pages requested at servers of the mobile wireless internet service provider.

12. A method for mapping and comparing characteristics of web page data requested by a mobile wireless internet service subscriber/user to user set options/criteria and the bandwidth available for the mobile wireless transmission of such web page data to the user's mobile wireless internet device.

13. A method for reduction of bandwidth requirements based on user-specified bandwidth trade-off options.

14. A method as recited in claim 13, wherein the reduction of bandwidth requirements is based on the user-specified bandwidth trade-off options and available buffer capacity at the user's wireless internet service provider.

15. A keyboard module contains a subset key set of a complete computer keyboard.

16. A keyboard module that contains one of: (1) only the Left Half Part of a complete computer keyboard; (2) only the Right Half Part of a complete computer keyboard; (3) only the Left One Third Part (Right 33.3%) of a complete computer keyboard; (4) only the Middle One Third Part (Right 33.3%) of a complete computer keyboard; and (5) only the Right One Third Part (Right 33.3%) of a complete computer keyboard.
